(19) United States
(12) Patent Application Publication
(10) Pub. No.: US 2006/0220345 A1
(43) Pub. Date: Oct. 5, 2006

(54) Trailer hitch alignment system and method

(76) Inventor: Robert Schmidt, Lapeer, MI (US)

Correspondence Address: LAW OFFICE OF TIMOTHY M. BARLOW, P.O. BOX 523272, SPRINGFIELD, VA, 22152, US

(21) Appl. No.: 11/366,179

(22) Filed: Mar. 2, 2006

Related U.S. Application Data
(60) Provisional application No. 60/666,269, filed on Mar. 30, 2005.
(60) Provisional application No. 60/707,939, filed on Aug. 15, 2005.

(51) Int. Cl. B60D 1/36

(52) U.S. Cl. 280/477

(57) ABSTRACT

A trailer hitch alignment system includes a hitch bracket in the form of an upright C-shaped frame with a top member and a bottom member connected by a single side member. A striker plate is fixed to the bottom member of the hitch bracket. At least one magnet is attached to the hitch bracket. A telescoping mast is attached to the top member of the hitch bracket and a non-marring ball is attached to the top of the mast. The magnet is attached inside the upright C-shaped frame to the bottom member of the hitch bracket. The bracket is attached below the hitch receptacle on a trailer with the striker plate projecting downward. The vehicle's trailer hitch contacts the striker plate and deflects it when the hitch and trailer are properly oriented for coupling. The mast and ball move to alert the vehicle driver of the proper orientation.

### PRIORITY DATA

The present invention claims priority on provisional patent applications, Serial No. 60/666,269, filed on Mar. 30, 2005, entitled “Trailer Hitch Alignment Device”, and 60/707,939, filed on Aug. 15, 2005, entitled “Trailer Hitch Alignment Device” and are hereby incorporated by reference.

### FIELD OF THE INVENTION

The present invention relates generally to the field of alignment tools and more particularly to a trailer hitch alignment system and method.

### BACKGROUND OF THE INVENTION

Coupling a trailer to the hitch on a towing vehicle can be a tricky task. It is difficult to judge the position of the trailer's tongue in relation to the hitch, from the driver's seat. This task is made simpler with an assistant or two to guide the driver into the correct position for the trailer to be coupled. However, sometimes the driver of the towing vehicle is alone and without any assistants. It may not be possible to wait for someone to become available to assist. In such cases the driver must do his best. This can easily result in damage to the towing vehicle or trailer.

If the driver backs up too close to the trailer, the trailer can impact the towing vehicle and dent or scratch the vehicle's bumper, trim or body. Alternatively, the driver can back up in one- or two-foot increments, visually inspecting the relationship between the trailer and the towing vehicle at each stop. This process is awkward and inexact at best, and harmful at worst. Several solutions to this problem have been proposed over the years. These devices range from rigid steel guides that rely on trailer impact, to trailer- or vehicle-mounted mirrors, to twin-pole alignment systems. Some of these devices are permanently attached to the trailer or towing vehicle, thus exposing the device to unnecessary wear and tear and requiring permanent modification of the trailer of towing vehicle.

Thus, what is desired is a trailer hitch alignment system that provides quick and easy alignment of the trailer hitch with a trailer, without permanent alterations to the vehicle or trailer.

### SUMMARY OF INVENTION

A trailer hitch alignment system includes a hitch bracket in the form of an upright C-shaped frame with a top member and a bottom member connected by a single side member. A striker plate is fixed to the bottom member of the hitch bracket. At least one magnet is attached to the hitch bracket. A telescoping mast is attached to the top member of the hitch bracket and a non-marring ball or tip is attached to the top of the mast. The magnet is attached inside the upright C-shaped frame to the bottom member of the hitch bracket. The bracket is attached below the hitch receptacle on a trailer with the striker plate projecting downward. The vehicle's trailer hitch contacts the striker plate and deflects it when the hitch and trailer are properly oriented for coupling. In response to this deflection, the mast and ball move to alert the vehicle driver of the proper orientation.

### BRIEF DESCRIPTION OF THE DRAWINGS

FIG. 1 is a perspective view of a trailer hitch alignment system, in accordance with the present invention;

FIG. 2 is an environmental view of the trailer hitch alignment system, in accordance with the present invention;

FIG. 3 is a sequential perspective view of the trailer hitch alignment system, in accordance with the present invention; and

FIG. 4 is a perspective view of different embodiments of the trailer hitch alignment system, in accordance with the present invention.

### DETAILED DESCRIPTION OF THE DRAWINGS

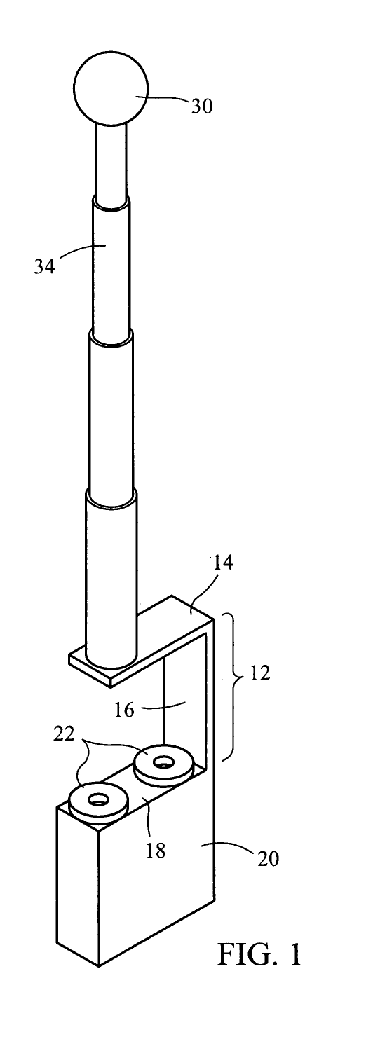

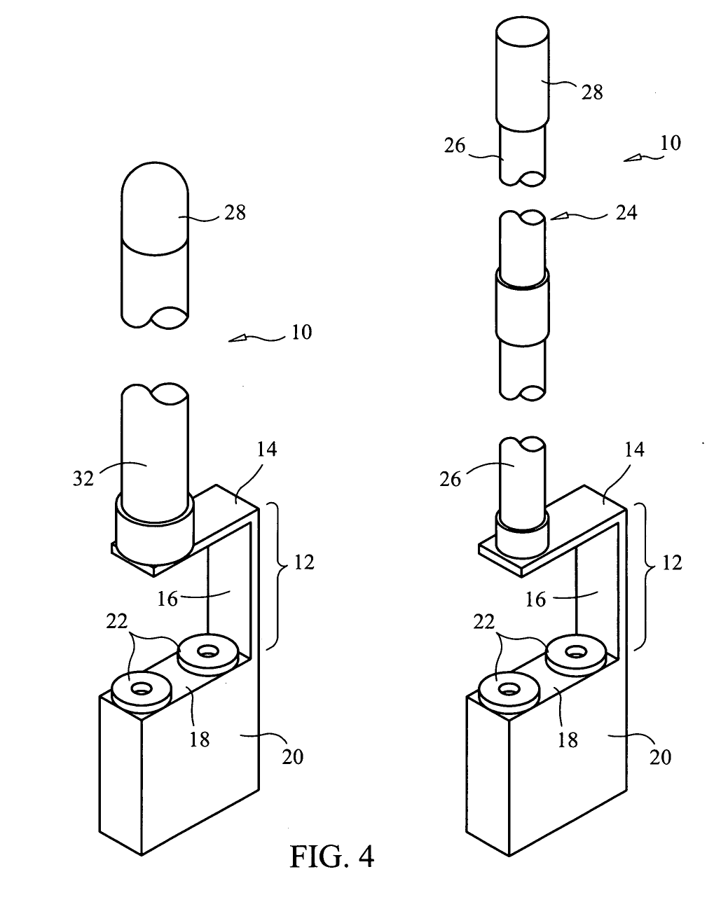

FIGS. 1 and 4 illustrate perspective views of the trailer hitch alignment system 10. The alignment system 10 includes a hitch bracket 12 with an upright C-shaped frame. The C-shaped frame has a top member 14 and a bottom member 18 connected by a single side member 16. This leaves one side open. A striker plate 20 is fixed to the bottom member 18 of the hitch bracket 12. The striker plate 20 extends downward from the hitch bracket 12. At least one magnet 22 is attached to the hitch bracket 12. In one embodiment, the magnet 22 is attached to the bottom member 18 of the hitch bracket 12. A mast 24 is attached to the top member 14 of the hitch bracket 12.

In one embodiment, the mast 24 includes several shorter segments 26 that can be pieced together to create a mast 24 that can be seen by the driver of the towing vehicle. To aid in visibility, the mast 24 can include a bright, high-visibility tip 28. In another embodiment, the mast 24 includes a ball 30 attached to the top of the mast 24. The mast 24 may be inflatable or a soft foam or plastic 32, or may be a telescoping mast 34 as shown in FIG. 4. Preferably, the tip 28 or ball 30 is made of a material that will not mar the finish of the trailer or the towing vehicle.

The magnet 22 must be strong enough to support the entire weight of the alignment system 10. In one embodiment, the magnet 22 is attached inside the upright C-shaped frame to the bottom member 18 of the hitch bracket 12. Two or more magnets 22 can be used to meet the system's requirements. The entire alignment system 10 can be made from lightweight plastics or similar materials to decrease the load on the magnets 22.

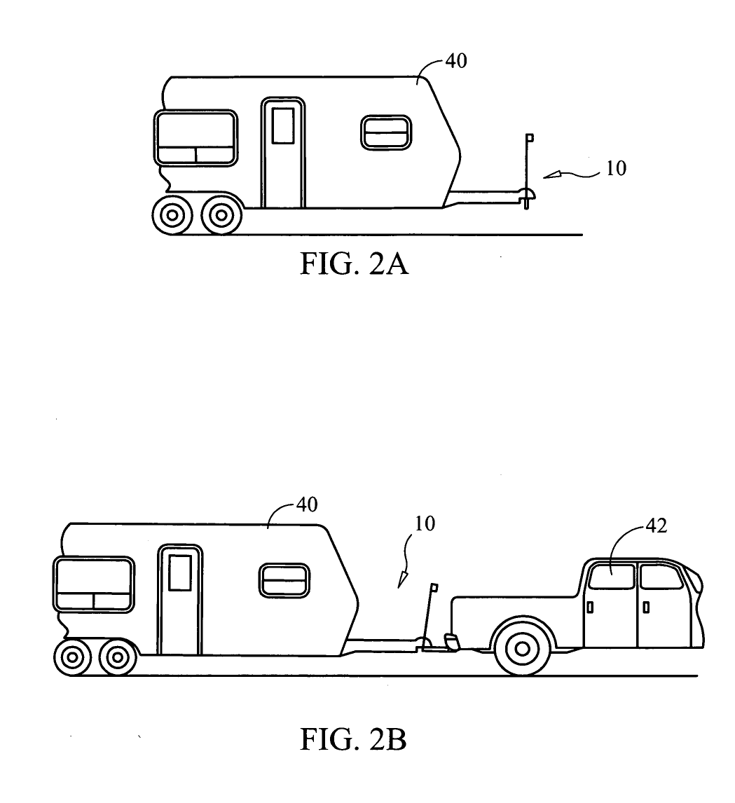

FIG. 2 is an environmental view of the alignment system 10 in use. FIG. 2A shows the proper orientation of the system 10 mounted to a trailer 40. The mast 24 is vertically oriented. FIG. 2B shows a towing vehicle 42 backed up to the trailer 40 so as to displace the system 10 from its original position from FIG. 2A. Notice that in FIG. 2B, the mast 24 is no longer vertical. This displacement of the mast 24 signals the driver of the vehicle 42 that he is in the correct position for coupling the trailer 40 and towing vehicle 42.

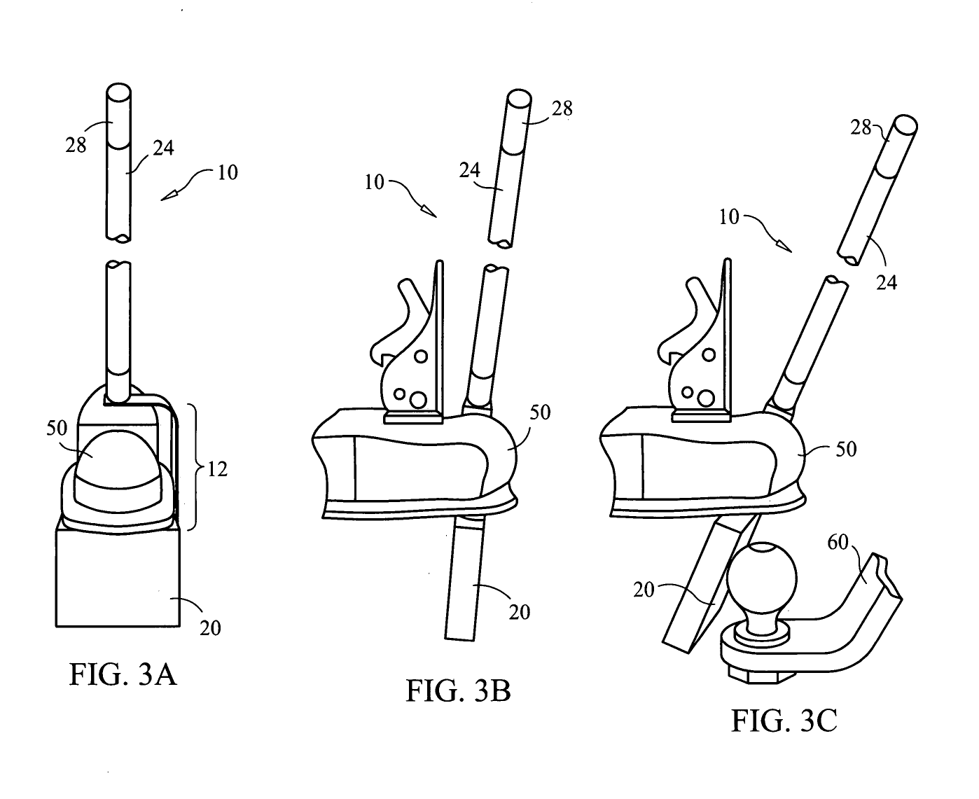

FIG. 3 is a close-up view of the alignment process. FIG. 3A shows a front view of a trailer tongue's hitch ball receptacle 50 with an alignment system 10 attached. Notice that the striker plate 20 is approximately the same width as the hitch ball receptacle 50. FIG. 3b shows a side view of the hitch ball receptacle 50 with the alignment system 10 attached. Notice that the magnets 22 removably attach to the bottom of the hitch ball receptacle 50. Only the bottom member 18 of the hitch bracket 12 contacts the hitch ball receptacle 50. This permits the alignment system 10 to deflect while remaining attached to the hitch ball receptacle 50. Alternatively, the alignment 10 can detach and drop from the hitch ball receptacle 50 in response to contact from the trailer hitch 60.

The alignment system 10 is easy to use. First, the trailer hitch alignment system 10 is attached to a hitch ball receptacle 50 on a trailer tongue. In another embodiment, instead of a ball-type hitch coupling, a pintle hitch can be used. In the preferred embodiment, the attachment of the alignment system 10 to the hitch ball receptacle 50 is magnetic. The trailer tongue should be adjusted so that the hitch ball receptacle 50 is slightly above the vehicle trailer hitch 60. Next, the driver maneuvers the vehicle trailer hitch 60 into close proximity with the trailer hitch receptacle 50. As the trailer hitch 60 approaches proper alignment with the hitch ball receptacle 50, the trailer hitch 60 contacts and deflects the striker plate 20 of the trailer hitch alignment system 10. From the driver's seat, the driver observes the deflection of the trailer hitch alignment system 10. The driver will actually be able to observe the mast 24 moving from its vertical position. As the alignment system 10 is deflected, the trailer hitch 60 and the hitch ball receptacle 50 are in proper alignment for coupling. Next, the driver stops the vehicle and removes the trailer hitch alignment system 10 from the hitch ball receptacle 50. Finally, the driver couples the trailer hitch receptacle 50 to the trailer hitch 60. The alignment system 10 can be disassembled or collapsed and stored in the towing vehicle 42 or trailer 40 for later use.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A trailer hitch alignment system comprising:
a hitch bracket, comprising an upright C-shaped frame having a top member and a bottom member connected by a single side member;
a striker plate fixed to the bottom member of the hitch bracket;
at least one magnet attached to the hitch bracket; and
a mast attached to the top member of the hitch bracket.

2. The trailer hitch alignment system of claim 1, further comprising a ball attached to the top of the mast.

3. The trailer hitch alignment system of claim 1, where the at least one magnet is attached inside the upright C-shaped frame to the bottom member of the hitch bracket.

4. The trailer hitch alignment system of claim 1, where the mast is a telescoping mast.

5. The trailer hitch alignment system of claim 2, where the ball further comprises a non-marring material.

6. A method of aligning a trailer with a vehicle trailer hitch, comprising the steps of:
(a) removably attaching a trailer hitch alignment target to a trailer hitch receptacle on a trailer tongue;
(b) maneuvering the vehicle trailer hitch to close proximity with the trailer hitch receptacle;
(c) deflecting a striker plate attached to the trailer hitch alignment target with the vehicle trailer hitch;
(d) observing the deflection of the trailer hitch alignment target;
(e) stopping the vehicle;
(f) removing the trailer hitch alignment target from the trailer; and
(g) coupling the trailer hitch receptacle to the trailer hitch.

7. The method of aligning a trailer with a vehicle trailer hitch of claim 6, where step (a) further comprises the step of:
(a1) magnetically attaching the trailer hitch alignment target to the trailer hitch receptacle on the trailer tongue.

8. The method of aligning a trailer with a vehicle trailer hitch of claim 6, where the trailer hitch receptacle is a hitch ball receptacle.

9. The method of aligning a trailer with a vehicle trailer hitch of claim 6, where the trailer hitch receptacle is a pintle hitch receptacle.

10. The method of aligning a trailer with a vehicle trailer hitch of claim 6, where step (a) further comprises the step of:
(a1) attaching the trailer hitch alignment target to a bottom side of the trailer hitch receptacle.

11. The method of aligning a trailer with a vehicle trailer hitch of claim 6, where step (a) further comprises the step of:
(a1) extending a mast attached to the trailer hitch alignment target.

12. The method of aligning a trailer with a vehicle trailer hitch of claim 6, where step (a) further comprises the step of:
(a1) raising a trailer tongue to a height slightly above the vehicle trailer hitch.

13. The method of aligning a trailer with a vehicle trailer hitch of claim 6, where step (c) further comprises the step of:
(c1) displacing a mast attached atop the trailer hitch alignment target.

14. The method of aligning a trailer with a vehicle trailer hitch of claim 6, where step (d) further comprises the step of:
(d1) observing the displacement of the mast.

15. A trailer hitch alignment system comprising:
a hitch bracket, comprising an upright C-shaped frame having a top member and a bottom member connected by a single side member;
a striker plate fixed to the bottom member of the hitch bracket;
at least one magnet attached to the hitch bracket;
a mast attached to the top member of the hitch bracket; and
a ball attached to the top of the mast.

16. The trailer hitch alignment system of claim 15, where the at least one magnet is attached inside the upright C-shaped frame to the bottom member of the hitch bracket.

17. The trailer hitch alignment system of claim 15, where the mast is a telescoping mast.

18. The trailer hitch alignment system of claim 15, where the ball further comprises a non-marring material.
